(19) United States
(12) Patent Application Publication
(10) Pub. No.: US 2012/0002129 A1
(43) Pub. Date: Jan. 5, 2012

(54) Electronic device comprising liquid crystal display panel

(75) Inventor: Kouji Azai, Echizen-shi (JP)

(73) Assignee: Orion Electric Company, Ltd.

(21) Appl. No.: 13/067,879

(22) Filed: Jul. 1, 2011

(30) Foreign Application Priority Data
Jul. 1, 2010 (JP) 2010-151155

(51) Int. Cl. G02F 1/1335

(52) U.S. Cl. 349/58

(57) ABSTRACT

The present invention provides an electronic device comprising a liquid crystal display panel, which even when thickness of an exterior member serving as an exterior of a liquid crystal display panel, and particularly thickness of a front bezel is reduced, can suppress deformation such as twist and deflection of a liquid crystal cell by a simple structure and has a good assembling workability.

Fitting lock portions having a substantially T shape are provided at the upper and lower portions of a middle frame, and a front bezel has cut-out portions in which the fitting lock portions are inserted and fitted. The fitting lock portions of the middle frame are inserted and fitted in the cut-out portions of the front bezel, whereby the substantially T-shaped fitting lock portions increase the strength of the front bezel, and the deformation such as twist and deflection of a liquid crystal cell can be suppressed.

### BACKGROUND OF THE INVENTION

1. Field of Invention

The present invention relates to an electronic device comprising a liquid crystal display panel and relates particularly to a structure of an exterior member serving as an exterior of a liquid crystal display panel.

2. Description of the Related Art

A liquid crystal display panel is widely used in electronic devices including a home television receiver and a monitor for a personal computer (PC) and basically constituted of a liquid crystal cell transmitting or blocking light, alight source irradiating light from a back surface side of the liquid crystal cell, and an exterior member assembling the liquid crystal cell and the light source and serving as an exterior of the liquid crystal display panel. The light irradiated from the light source is transmitted through or blocked by the liquid crystal cell, whereby an image can be displayed on the liquid crystal display panel.

The exterior member is generally constituted mainly of a back chassis located on the rearward side of the light source and a front bezel located adjacent to a front outer peripheral edge of the liquid crystal cell. The strength of the exterior member is required in order to suppress deformation such as twist and deflection of the liquid crystal cell.

Thus, Japanese Patent Application Laid-Open No. 2008-197166 describes a structure that the deformation such as twist and deflection of the liquid crystal cell is suppressed by a simple structure. Specifically, in a front bezel constituting a rectangular frame body constituted of a first support frame and a second support frame divided into four parts, a first connection protrusion and a second connection protrusion for connecting to the second support frame are formed at both ends of the first support frame. A first through-hole and a third through-hole of the first connection protrusion overlap, and a second through-hole and a fourth through-hole of the second connection protrusion overlap. The first and third through-holes are jointly fastened to a first female screw hole, and the second and fourth through-holes are jointly fastened to a second female screw hole.

Japanese Patent Application Laid-Open No. 2005-114838 describes a structure of a liquid crystal display panel capable of reducing the number of components and assembling man-hours. Specifically, in the liquid crystal display panel comprising a resin frame, a bezel, and a liquid crystal cell, the frame includes a groove having a substantially semicircular shaped upper portion and a circular arc protrusion. The upper portion is formed in a substantially semicircular shape so as to follow the shape of the outer periphery of a cylindrical insert nut provided on the side surface of the bezel. The protrusion is provided on at least one side surface so that the distance from the facing side surface is smaller than the outer diameter of the insert nut and is used for fixing the insert nut to the upper portion.

### SUMMARY OF THE INVENTION

According to the structure of the Japanese Patent Application Laid-Open No. 2008-197166, although the connection portions of the front bezel constituted by being divided into four can be rigidly fixed to each other by joint fastening with screws, sufficient strength cannot be obtained at a substantially central portion of the first support frame and the second support frame, so that the deformation such as twist and deflection of the liquid crystal cell to be attached may occur. Namely, in recent liquid crystal display panels, thickness of components is reviewed for reduction of the thickness, weight, or cost. When the thickness of the first and second support frames constituting the front bezel is reduced, and only the connection portions are rigidly fixed with screws, the deformation due to the reduction of the strength at the substantially central portion of the first support frame and the second support frame is concerned, and the risk of image disturbance and a breakage of the liquid crystal cell associated with the deformation occurs.

Meanwhile, according to the structure of the Japanese Patent Application Laid-Open No. 2005-114838, the insert nut provided on the side surface of the bezel is fitted in the groove provided in the resin frame, whereby the screws for fixing can be reduced in number. However, when the thickness of the bezel is reduced, it is difficult to obtain sufficient strength at the substantially central portion as in the case of the Japanese Patent Application Laid-Open No. 2008-197166. Moreover, increase in cost due to the provision of the insert nut of the bezel is feared.

In view of the above problems, the present invention provides an electronic device comprising a liquid crystal display panel, which even when thickness of an exterior member serving as an exterior of a liquid crystal display panel, and particularly thickness of a front bezel is reduced, can suppress deformation such as twist and deflection of a liquid crystal cell by a simple structure and has a good assembling workability.

In an electronic device comprising a liquid crystal display panel according to a first aspect of the invention, the liquid crystal display panel is constituted mainly of a light source, a light guide plate inducing light from the light source, a back chassis accommodating the light source and the light guide plate, an optical sheet arranged at a position facing the back chassis through the light guide plate, a middle frame, a liquid crystal cell displaying an image, and a front bezel. The liquid crystal display panel is characterized in that the middle frame has a substantially T-shaped fitting lock portion, and the front bezel has a cut-out portion in which the fitting lock portion is inserted and fitted.

An electronic device comprising a liquid crystal display panel according to a second aspect of the invention is the electronic apparatus comprising the liquid crystal display panel according to the first aspect. The electronic device is characterized in that the back chassis has a cut-and-raised portion, and the middle frame has an engagement hole with which the cut-and-raised portion is engaged.

An electronic device comprising a liquid crystal display panel according to a third aspect of the invention is the electronic apparatus comprising the liquid crystal display panel according to any one of the first aspect and the second aspect. The electronic device is characterized in that the back chassis has an engagement claw, and the front bezel has an engagement hook engaged with the engagement claw.

An electronic device comprising a liquid crystal display panel according to a fourth aspect of the invention is the electronic apparatus comprising the liquid crystal display panel according to any one of the first aspect and the second aspect. The electronic device is characterized in that the front bezel is constituted of four components including two first front bezels and two second front bezels. The first front bezels engage at upper and lower portions of the back chassis and the middle frame, and have the same shape at sides opposite each other. The second front bezels engage at the respective left and right sides of the back chassis and the middle frame, and have the same shape at sides opposite each other.

An electronic device comprising a liquid crystal display panel according to a fifth aspect of the invention is the electronic apparatus comprising the liquid crystal display panel according to any one of the first aspect and the second aspect. The electronic device is characterized in that the back chassis has an engagement claw, and the front bezel has an engagement hook engaged with the engagement claw and that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

An electronic device comprising a liquid crystal display panel according to a sixth aspect of the invention is the electronic apparatus comprising the liquid crystal display panel according to any one of the first aspect and the second aspect. The electronic device is characterized in that the front bezel is fastened together with the back chassis by a screw and that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

An electronic device comprising a liquid crystal display panel according to a seventh aspect of the invention is the electronic apparatus comprising the liquid crystal display panel according to any one of the first aspect and the second aspect. The electronic device is characterized in that the back chassis has an engagement claw, and the front bezel has an engagement hook engaged with the engagement claw, that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other, and that the front bezel is fastened together with the back chassis by a screw.

According to the above constitutions of the present invention, the fitting lock portion of the middle frame is inserted and fitted in the cut-out portion of the front bezel, whereby the substantially T-shaped fitting lock portion increases the strength of the front bezel. Therefore, even when the thickness of the front bezel is reduced, the deformation such as twist and deflection of the liquid crystal cell can be suppressed. Moreover, the front bezel, the middle frame, and the back chassis can be rigidly assembled by a plurality of engagement portions, and fastening with screws can be reduced; therefore, an assembling workability of the liquid crystal display panel is improved.

### BRIEF DESCRIPTION OF THE DRAWINGS

FIG. 1 is a perspective view showing an electronic device comprising a liquid crystal display panel in an embodiment of the present invention;

FIG. 2 is an exploded perspective view of the liquid crystal display panel in the embodiment of the present invention;

FIG. 3 is a perspective view showing a state in which an LED substrate is attached to a back chassis in the embodiment of the present invention;

FIG. 4 is a partial enlarged perspective view showing a state before a middle frame is mounted in the embodiment of the present invention;

FIG. 5 is a partial enlarged perspective view showing the single middle frame in the embodiment of the present invention;

FIG. 6 is a perspective view showing a single first front bezel in the embodiment of the present invention;

FIG. 7 is a perspective view showing a single second front bezel in the embodiment of the present invention;

FIG. 8 is a partial enlarged perspective view showing a state before the first front bezel is attached in the embodiment of the present invention;

FIG. 9 is a partial enlarged perspective view showing a state after the first front bezel is attached in the embodiment of the present invention;

FIG. 10 is a partial enlarged perspective view showing a state before the second front bezel is attached in the embodiment of the present invention;

FIG. 11 is a partial enlarged perspective view showing a state after the second front bezel is attached in the embodiment of the present invention; and

FIG. 12 is a partial enlarged perspective view showing the vicinity of a fastening portion in the embodiment of the present invention.

### DESCRIPTION OF THE PREFERRED EMBODIMENT

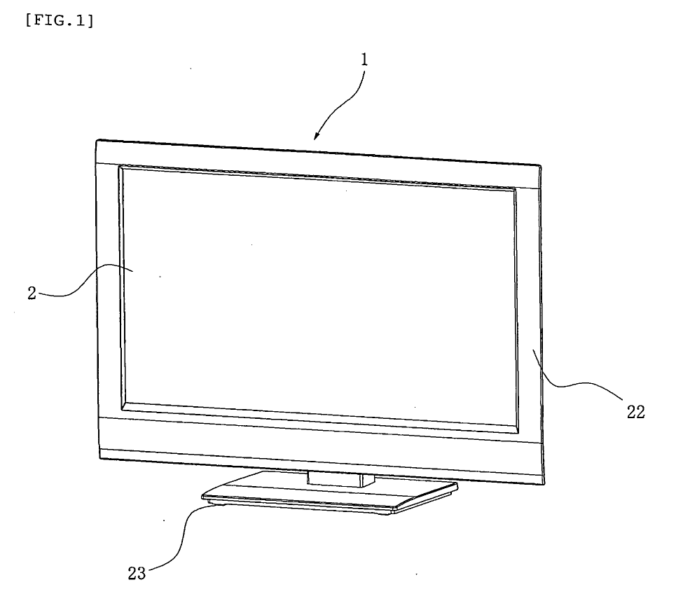

Hereinafter, an embodiment as the best mode for carrying out the present invention will be described with reference to FIGS. 1 to 12. The present invention is easily applicable to the constitution other than one to be described in the embodiment without departing from the spirit of the present invention.

FIG. 1 is a perspective view showing an electronic device comprising a liquid crystal display panel in an embodiment of the present invention. As shown in FIG. 1, an electronic device 1 comprising the liquid crystal display panel in the present embodiment includes a so-called home television receiver having a stand 23 and a product called a PC monitor, and various components including a liquid crystal display panel 2 are assembled inside a housing 22. The housing 22 has an opening, and a portion of the liquid crystal display panel 2 is exposed through the opening. The present invention is not limited to the home television receiver and the PC monitor and is widely applicable to products having a liquid crystal display panel.

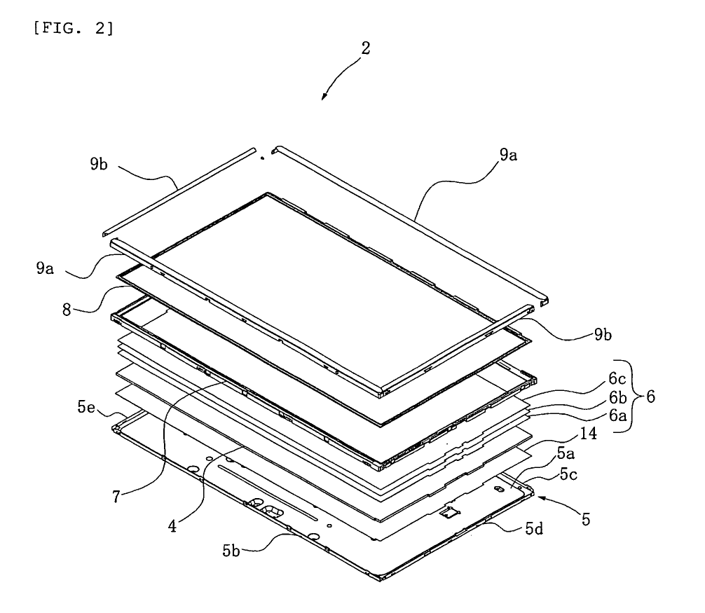

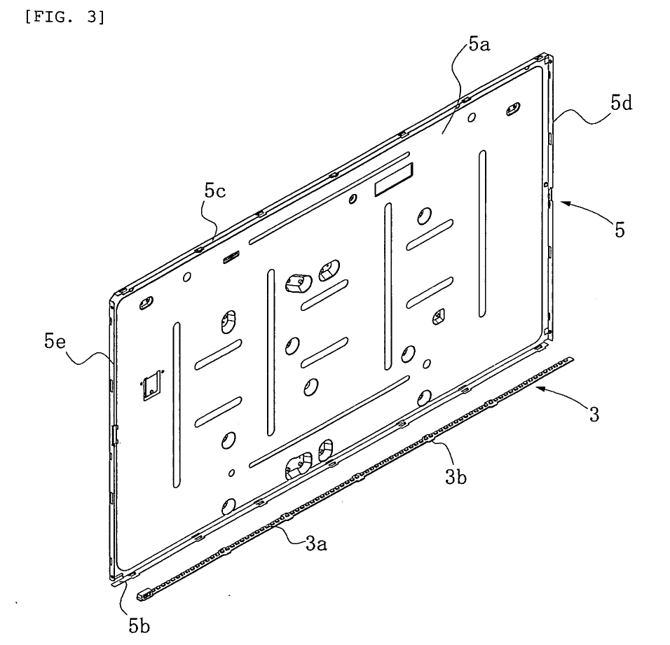

FIG. 2 is an exploded perspective view of the liquid crystal display panel in the embodiment of the present invention. FIG. 3 is a perspective view showing a state in which an LED substrate is attached to a back chassis in the embodiment of the present invention. As shown in FIGS. 2 and 3, the back chassis 5 constituting a back surface portion of the liquid crystal display panel 2 has such a shape that bent pieces 5b, 5c, 5d, and 5e are bent on four sides of a back surface portion 5a having a substantially rectangular shape. A light source 3 is attached near the bent piece 5b of the back chassis 5. In the present embodiment, a plurality of LEDs 3a are used as the light source 3, and an LED substrate 3b on which the LEDs 3a are arranged is applied near the bent piece 5b of the back chassis 5, using a double sided tape with a thermal conductivity. In the present embodiment, although the structure of the liquid crystal display panel 2 using the LEDs 3a as the light source will be continuously described, a cold cathode fluorescent lamp, for example, may be used as a light source instead of the LEDs 3a.

As shown in FIG. 2, a reflective sheet 14 is laid on the inner surface side of the back chassis 5 attached with the light source 3 for the purpose of improving the brightness of the light irradiated from the light source 3. In the present embodiment, although the reflective sheet 14 as a separate component is laid on the back chassis 5, the inner surface side of the back chassis 5 is previously formed by a color that improves the brightness of the light irradiated from the light source, or the inner surface side of the back chassis 5 is directly coated with a color that light easily reflects, for example, whereby the reflective sheet 14 can be omitted.

After the light source 3 and the reflective sheet 14 are attached to the back chassis 5, a light guide plate 4 is placed on the reflective sheet 14. The light guide plate 4 is used for receiving the light, irradiated from the light source 3 of the bent piece 5b of the back chassis 5, from one end surface and lighting a screen uniformly. In general, a light guide plate in which a dot pattern is printed on an acrylic resin surface is used.

Then, an optical sheet 6 is laid on a surface as a display surface of the light guide plate 4. The optical sheet 6 has a function of diffusing/converging the light irradiated from the light source 3 through the light guide plate 4 and substantially uniforming the light to one surface. The optical sheet 6 in the present embodiment is constituted of three components including a diffusion sheet 6a, a first lens sheet 6b, and a second lens sheet 6c. In the present invention, the number of components constituting the optical sheet 6 is not limited especially, and the optical sheet 6 may be constituted of a single component or four or more components.

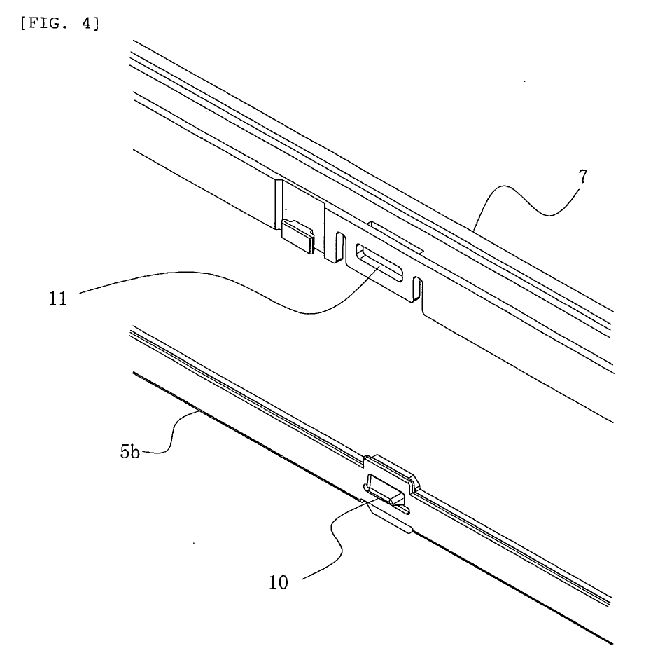

Next, a middle frame 7 for fixing the light guide plate 4 and the optical sheet 6 is mounted. The light guide plate 4 and the optical sheet 6 are fixed by being held between the middle frame 7 and the back chassis 5. The middle frame 7 in the embodiment of the present invention has a substantially frame shape so as to hold the whole circumferences of the light guide plate 4 and the optical sheet 6 and is provided with an engagement portion (hereinafter referred to as a first engagement portion) with which the middle frame 7 and the bent pieces 5b, 5c, 5d, and 5e of the back chassis 5 are engaged. FIG. 4 is a partial enlarged perspective view showing a state before the middle frame is mounted in the embodiment of the present invention. The first engagement portion in the present embodiment will be described in detail with reference to FIG. 4. The bent pieces 5b and 5c of the back chassis 5 are provided with cut-and-raised portions 10 cut and raised in the outer peripheral direction. The middle frame 7 is provided with engagement holes 11 with which the cut-and-raised portions 10 are engaged. The light source 3, the reflective sheet 14, the light guide plate 4, and the optical sheet 6 are attached to the back chassis 5, and thereafter, the middle frame 7 is mounted so that the cut-and-raised portions 10 are engaged with the engagement holes 11.

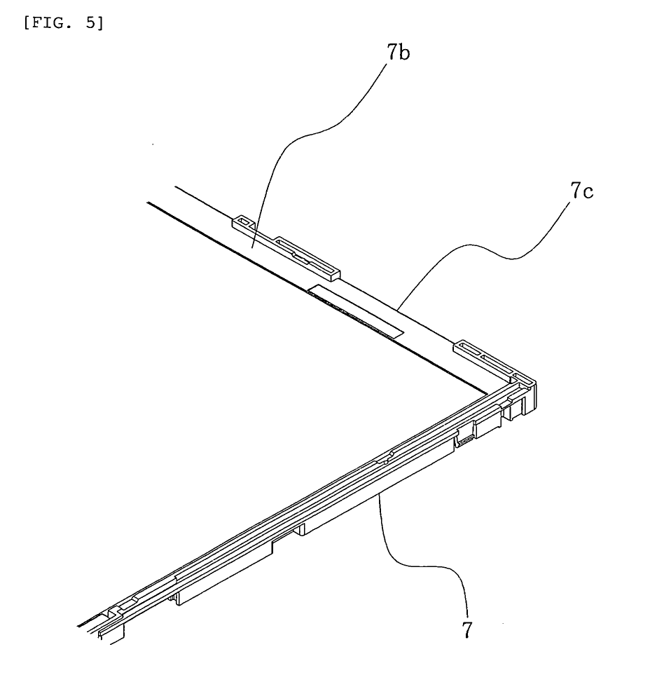

According to the above structure, the reflective sheet 14, the light guide plate 4, and the optical sheet 6 are fixed by the back chassis 5 and the middle frame 7 without removing from the back chassis 5, and a liquid crystal cell 8 for transmitting or blocking the light irradiated from the light source 3 is placed on the middle frame 7 in this state. FIG. 5 is a partial enlarged perspective view showing the single middle frame in the embodiment of the present invention. As shown in FIG. 5, in order to provide a small gap between the liquid crystal cell 8 and the optical sheet 6, the middle frame 7 has a placement portion 7b for the liquid crystal cell 8. The liquid crystal cell 8 is connected to a drive circuit substrate through a flexible printed wiring plate, and the drive circuit substrate is attached to the back surface portion 5a of the back chassis 5, and thus the middle frame 7 has a step portion 7c inducing the flexible printed wiring plate.

After the liquid crystal cell 8 is placed on the middle frame 7, a front bezel 9 is attached so that the liquid crystal cell 8 is not removed from the middle frame 7. The front bezel 9 in the embodiment of the present invention is constituted of four components including first front bezels 9a engaging at the upper and lower portions of the back chassis 5 and the middle frame 7 and second front bezels 9b engaging at the respective left and right sides of the back chassis 5 and the middle frame 7. The first front bezels 9a and the second front bezels 9b are attached in such a state that the liquid crystal cell 8 is placed on the placement portion 7b of the middle frame 7 and then screwed together with the back chassis 5. The first front bezels 9a engaging at the upper and lower portions of the back chassis 5 and the middle frame 7 have the same shape at sides thereof opposite each other. Similarly the second front bezels 9b engaging at the respective left and right sides of the back chassis 5 and the middle frame 7 have the same shape at sides thereof opposite each other.

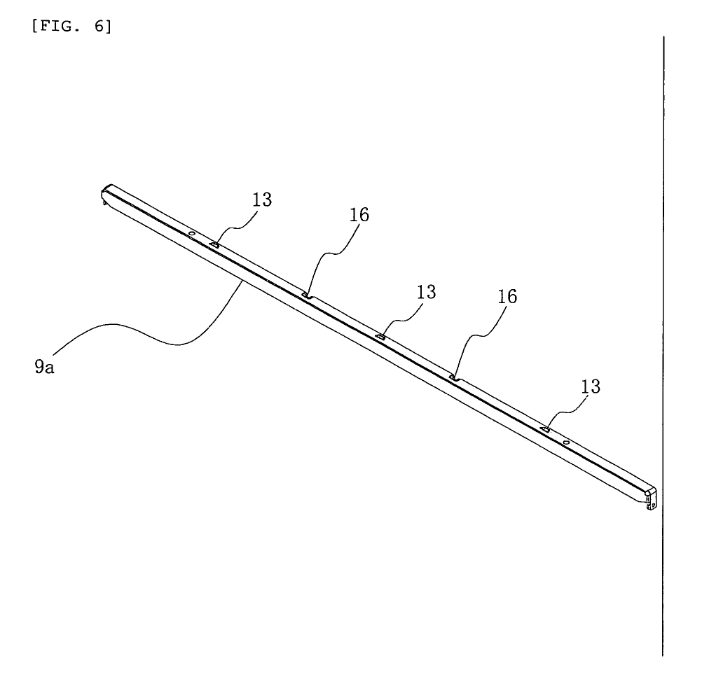

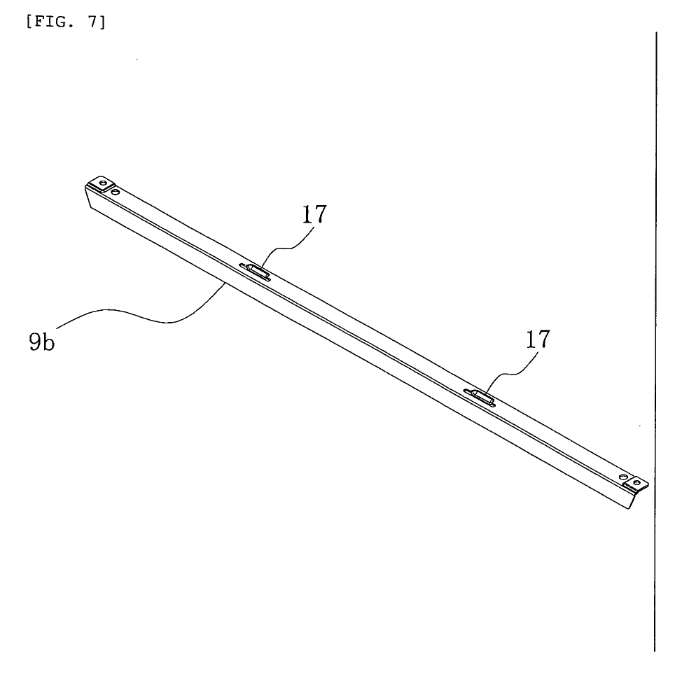

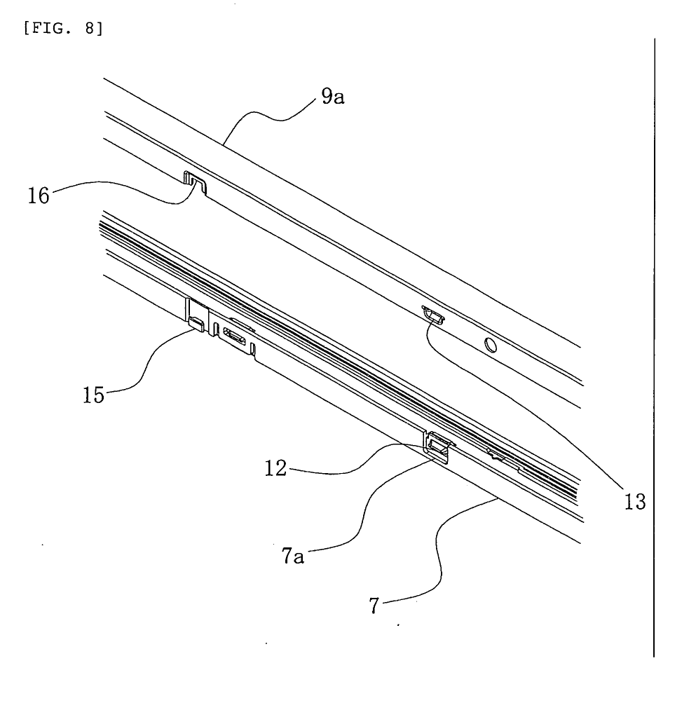

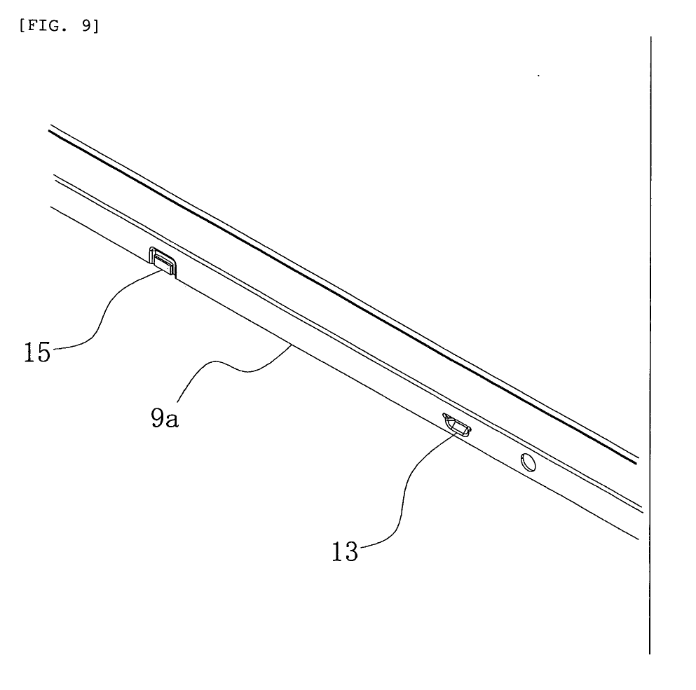

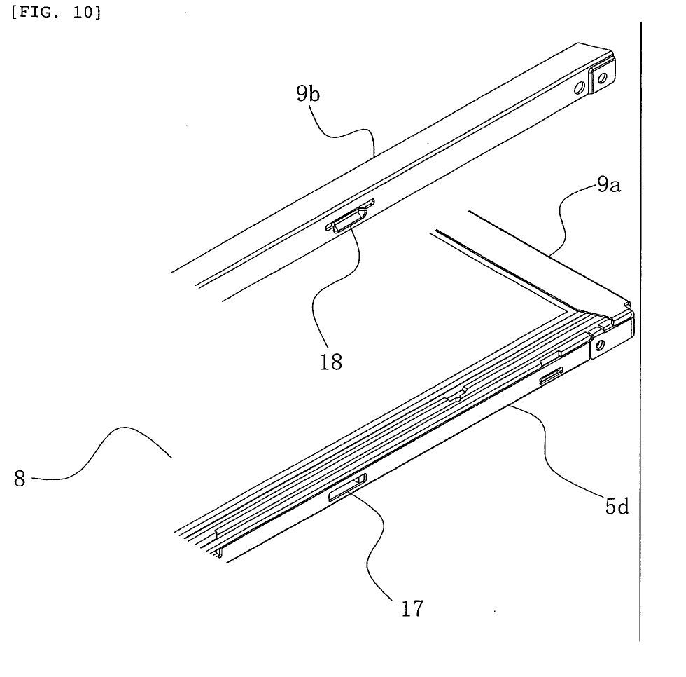

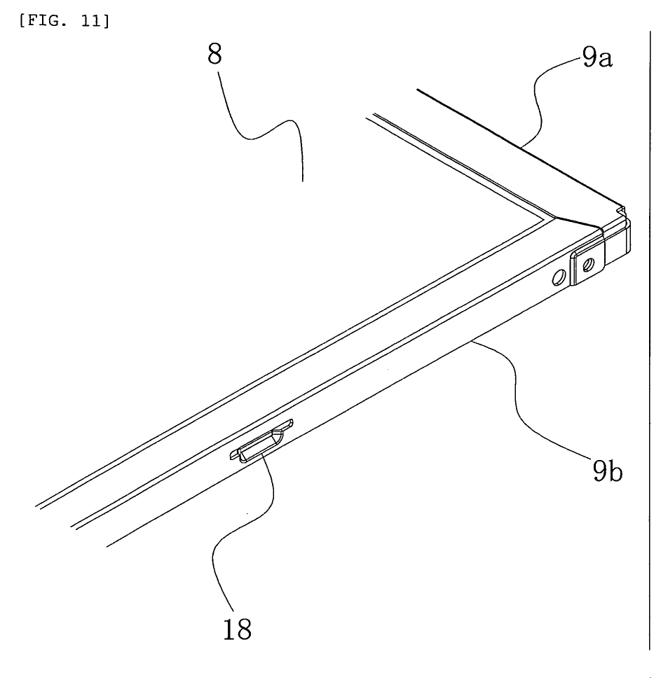

The attachment of the front bezel 9 in the present embodiment will be described in detail. FIG. 6 is a perspective view showing the single first front bezel in the embodiment of the present invention. FIG. 7 is a perspective view showing the single second front bezel in the embodiment of the present invention. FIG. 8 is a partial enlarged perspective view showing a state before the first front bezel is attached in the embodiment of the present invention. FIG. 9 is a partial enlarged perspective view showing a state after the first front bezel is attached in the embodiment of the present invention. FIG. 10 is a partial enlarged perspective view showing a state before the second front bezel is attached in the embodiment of the present invention. FIG. 11 is a partial enlarged perspective view showing a state after the second front bezel is attached in the embodiment of the present invention. As shown in FIGS. 6 and 7, the first front bezel 9a and the second front bezel 9b are bent so that the cross section has a substantially L shape, and the first front bezel 9a and the second front bezel 9b are attached so that the bent portion is abutted against the middle frame 7. As shown in FIGS. 8 and 9, the middle frame 7 has cutting off portions 7a at the upper and lower portions. Engagement claws 12 provided at the bent pieces 5b and 5c of the back chassis 5 are exposed from the cutting off portions 7a. The first front bezel 9a has engagement hooks 13 engaged with the engagement claws 12 of the back chassis 5. The bent pieces 5b and 5c of the back chassis 5 and the first front bezels 9a are engaged with each other by the engagement claws 12 and the engagement hooks 13 (hereinafter, the engagement is referred to as a second engagement portion).

An engagement portion (hereinafter referred to as a third engagement portion) is provided separately from the second engagement portion, and the first front bezels 9a and the middle frame 7 are engaged by the third engagement portion. The third engagement portion in the present embodiment will be described in detail with reference to FIGS. 8 and 9. The upper and lower portions of the middle frame 7 have fitting lock portions 15 having a substantially T shape, and the first front bezels 9a have cut-out portions 16 in which the fitting lock portions 15 are inserted and fitted. The fitting lock portions 15 shown in the present embodiment have a shape having both the attachment operation of the first front bezel 9a to the middle frame 7 and the operation of preventing detachment due to the deformation of the first front bezel 9a. Specifically, the fitting lock portions 15 of the middle frame 7 are inserted and fitted in the cut-out portions 16 of the first front bezel 9a, whereby the substantially T-shaped fitting lock portions 15 serve to suppress the outward deformation of the first front bezel 9a. As another method of preventing the detachment due to the deformation of the first front bezel 9a, it is easily considered that the thickness of the first front bezel 9a is increased to enhance the strength of the liquid crystal display panel 2. However, in this case, as well as cost up due to the increase in the thickness of the first front bezel 9a, the dimension of the outer peripheral edge of the liquid crystal display panel 2 is increased, and it is feared that the electronic device 1 becomes large in size. In other words, by virtue of the provision of the third engagement portion, even if the thickness of the first front bezel 9a is small, the deformation such as twist and deflection of the liquid crystal cell 8 can be suppressed, and cost can be reduced by reduction of material cost, so that the electronic device 1 in which the dimension of outer peripheral edge of the liquid crystal display panel 2 is reduced can be provided.

After the first front bezels 9a are attached to the middle frame 7, in order to attach the second front bezels 9b, an engagement portion (hereinafter referred to as a fourth engagement portion) engaging the second front bezel 9b and the bent pieces 5d and 5e of the back chassis 5 is provided. The fourth engagement portion in the present embodiment will be described in detail with reference to FIGS. 10 and 11. The bent pieces 5d and 5e of the back chassis 5 have engagement holes 17, and the second front bezels 9b have engaging projection pieces 18 engaged with the engagement holes 17. The engaging projection pieces 18 are engaged with the engagement holes 17 to attach the second front bezels 9b to the bent pieces 5d and 5e of the back chassis 5.

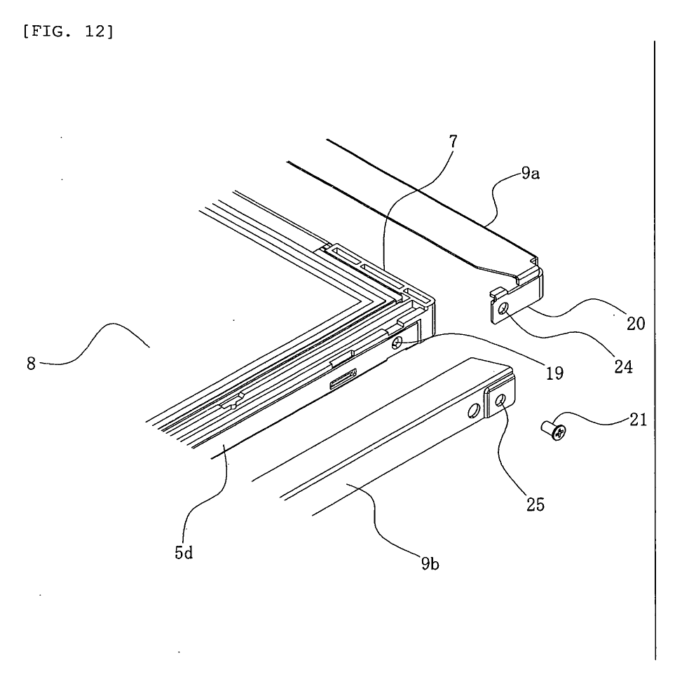

In the present embodiment, after the front bezel 9 is attached to the back chassis 5 and the middle frame 7, the back chassis 5 and the front bezel 9 are fastened by a screw. FIG. 12 is a partial enlarged perspective view showing the vicinity of a fastening portion in the embodiment of the present invention. In FIG. 12, the front bezel 9 is separated from the back chassis 5 so that the fastening portion between the back chassis 5 and the front bezel 9 is clearly shown. As shown in FIG. 12, the bent pieces 5d and 5e of the back chassis 5 have fastening holes 19 provided near the both ends. The first front bezels 9a have bent portions 20 at the both ends. The bent portions 20 each have a through-hole 24, and the second front bezels 9b each have a through-hole 25 provided near the both ends. When the front bezel 9 is attached to the back chassis 5 and the middle frame 7, the fastening holes 19, the through-holes 24 of the first front bezels 9a, and the through-holes 25 of the second front bezels 9b superpose each other. A screw 21 is fastened through the through-hole 25 in the above state, whereby the back chassis 5 and the front bezel 9 are screwed at four points.

Although one embodiment of the present invention has been described, the present invention is not limited to the embodiment, and the present invention can be variously modified and practiced without departing from the spirit of the present invention.

1. An electronic device comprising a liquid crystal display panel, which is constituted mainly of a light source, a light guide plate inducing light from the light source, a back chassis accommodating the light source and the light guide plate, an optical sheet arranged at a position facing the back chassis through the light guide plate, a middle frame, a liquid crystal cell displaying an image, and a front bezel, being characterized in that the middle frame has a substantially T-shaped fitting lock portion, and the front bezel has a cut-out portion in which the fitting lock portion is inserted and fitted.

2. The electronic device comprising a liquid crystal display panel according to claim 1, being characterized in that the back chassis has a cut-and-raised portion, and the middle frame has an engagement hole with which the cut-and-raised portion is engaged.

3. The electronic device comprising a liquid crystal display panel according to claim 1, being characterized in that the back chassis has an engagement claw, and the front bezel has an engagement hook engaged with the engagement claw.

4. The electronic device comprising a liquid crystal display panel according to claim 1, being characterized in that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

5. The electronic device comprising a liquid crystal display panel according to claim 1, being characterized in that the back chassis has an engagement claw, and the front bezel has an engagement hook engaged with the engagement claw and that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

6. The electronic device comprising a liquid crystal display panel according to claim 1, being characterized in that the front bezel is fastened together with the back chassis by a screw and that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

7. The electronic device comprising a liquid crystal display panel according to claim 1, being characterized in that the back chassis has an engagement claw, and the front bezel has an engagement hook engaged with the engagement claw, that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other, and that the front bezel is fastened together with the back chassis by a screw.

8. The electronic device comprising a liquid crystal display panel according to claim 2, being characterized in that the back chassis has an engagement claw, and the front bezel has an engagement hook engaged with the engagement claw.

9. The electronic device comprising a liquid crystal display panel according to claim 2, being characterized in that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

10. The electronic device comprising a liquid crystal display panel according to claim 2, being characterized in that the back chassis has an engagement claw, and the front bezel has an engagement hook engaged with the engagement claw and that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

11. The electronic device comprising a liquid crystal display panel according to claim 2, being characterized in that the front bezel is fastened together with the back chassis by a screw and that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other.

12. The electronic device comprising a liquid crystal display panel according to claim 2, being characterized in that the back chassis has an engagement claw, and the front bezel has an engagement hook engaged with the engagement claw, that the front bezel comprises four components including two first front bezels, which engage at upper and lower portions of the back chassis and the middle frame, and have the same shape at sides opposite each other, and two second front bezels which engage at the respective left and right sides of the back chassis and the middle frame, and have the same shape at sides opposite each other, and that the front bezel is fastened together with the back chassis by a screw.
